(19) United States
(12) Patent Application Publication
(10) Pub. No.: US 2023/0177316 A1
(43) Pub. Date: Jun. 8, 2023

(54) MODEL GENERATION METHOD, COMPUTER PROGRAM PRODUCT, MODEL GENERATION DEVICE, AND DATA PROCESSING DEVICE

(71) Applicant: DENSO CORPORATION, Kariya-city (JP)

(72) Inventor: YUKI ASADA, Kariya-city (JP)

(21) Appl. No.: 18/060,951

(22) Filed: Dec. 1, 2022

(30) Foreign Application Priority Data
Dec. 6, 2021 (JP) 2021-198049

(51) Int. Cl. G06N 3/0464; G06F 17/16

(52) U.S. Cl. CPC G06N 3/0464; G06F 17/16

(57) ABSTRACT

A model generation method is for generating a machine learning model by replacing a convolution layer of a convolutional neural network with a decomposition layer by matrix decomposition. The model generation method includes sorting weight parameters constituting an original layer of the convolution layer to constitute an equivalent weight matrix equivalent to a weight matrix product which is a product of matrices of weight parameters constituting the decomposition layer, extracting a plurality of ranks by matrix decomposition on the equivalent weight matrix, and building the decomposition layer based on convolution of the weight matrix product corresponding to at least one selected ranks selected from the plurality of ranks.

### CROSS REFERENCE TO RELATED APPLICATION

This application is based on and incorporates herein by reference Japanese Patent Application No. 2021-198049 filed on Dec. 6, 2021.

### TECHNICAL FIELD

The present disclosure relates to model generation techniques for generating machine learning models of convolutional neural networks.

### BACKGROUND

In a known model generation technique, the machine learning model is compressed by lowering the rank of the weight matrix after matrix decomposition of the weight matrix composed of weight parameters in the convolution layer of the convolutional neural network.

### SUMMARY

A first aspect of the present disclosure is a model generation method for a processor to generate a machine learning model by replacing a convolution layer of a convolutional neural network with a decomposition layer by matrix decomposition. The model generation method includes: sorting weight parameters constituting an original layer of the convolution layer to constitute an equivalent weight matrix equivalent to a weight matrix product which is a product of matrices of weight parameters constituting the decomposition layer; extracting a plurality of ranks by matrix decomposition on the equivalent weight matrix; and building the decomposition layer based on convolution of the weight matrix product corresponding to at least one selected ranks selected from the plurality of ranks.

A second aspect of the present disclosure is a computer program product stored on at least one non-transitory computer readable medium for generating a machine learning model by replacing a convolution layer of a convolutional neural network with a decomposition layer by matrix decomposition. The model generation program includes instructions configured to, when executed by at least one processor, cause the at least one processor to: sort weight parameters constituting an original layer of the convolution layer to constitute an equivalent weight matrix equivalent to a weight matrix product which is a product of matrices of weight parameters constituting the decomposition layer; extract a plurality of ranks by matrix decomposition on the equivalent weight matrix; and build the decomposition layer based on convolution of the weight matrix product corresponding to at least one selected ranks selected from the plurality of ranks.
A third aspect of the present disclosure is a model generation device configured to generate a machine learning model by replacing a convolution layer of a convolutional neural network with a decomposition layer by matrix decomposition.

The model generation device includes a processor configured to: sort weight parameters constituting an original layer of the convolution layer to constitute an equivalent weight matrix equivalent to a weight matrix product which is a product of matrices of weight parameters constituting the decomposition layer; extract a plurality of ranks by matrix decomposition on the equivalent weight matrix; and build the decomposition layer based on convolution of the weight matrix product corresponding to at least one selected ranks selected from the plurality of ranks.

A fourth aspect of the present disclosure is a data processing device including a storage medium that stores the machine learning model of the convolutional neural network generated by the model generation method according to the first aspect, and a processor configured to execute data processing based on the machine learning model stored in the storage medium.

### BRIEF DESCRIPTION OF THE DRAWINGS

FIG. 1 is a block diagram illustrating an overall configuration according to a first embodiment.

FIG. 2 is a schematic diagram for explaining a machine learning model according to the first embodiment.

FIG. 3 is a schematic diagram for explaining an initial layer according to the first embodiment.

FIG. 4 is a schematic diagram for explaining a decomposition layer according to the first embodiment.

FIG. 5 is a schematic diagram for explaining the initial layer according to the first embodiment.

FIG. 6 is a schematic diagram for explaining the decomposition layer according to the first embodiment.

FIG. 7 is a block diagram illustrating a functional configuration of a model generation device according to the first embodiment.

FIG. 8 is a flowchart showing a model generation flow according to the first embodiment.

FIG. 9 is a schematic diagram for explaining a sorting process according to the first embodiment.

FIG. 10 is a schematic diagram for explaining the sorting process according to the first embodiment.

FIG. 11 is a schematic diagram for explaining the sorting process according to the first embodiment.

FIG. 12 is a schematic diagram for explaining the sorting process according to the first embodiment.

FIG. 13 is a schematic diagram for explaining a rank extraction process according to the first embodiment.

FIG. 14 is a schematic diagram for explaining a layer building process according to the first embodiment.

FIG. 15 is a schematic diagram for explaining the layer building process according to the first embodiment.

FIG. 16 is a schematic diagram for explaining a decomposition layer according to a second embodiment.

FIG. 17 is a schematic diagram for explaining the decomposition layer according to the second embodiment.

FIG. 18 is a flowchart showing a model generation flow according to the second embodiment.

FIG. 19 is a schematic diagram for explaining a sorting process according to the second embodiment.

FIG. 20 is a schematic diagram for explaining a layer building process according to the second embodiment.

FIG. 21 is a schematic diagram for explaining the layer building process according to the second embodiment.

FIG. 22 is a schematic diagram for explaining a secondary decomposition layer according to a third embodiment.

FIG. 23 is a schematic diagram for explaining a primary decomposition layer according to the third embodiment.

FIG. 24 is a schematic diagram for explaining the secondary decomposition layer according to the third embodiment.

FIG. 25 is a flowchart showing a model generation flow according to the third embodiment.

FIG. 26 is a schematic diagram for explaining a sorting process according to the third embodiment.

FIG. 27 is a schematic diagram for explaining a layer building process according to the third embodiment.

FIG. 28 is a schematic diagram for explaining the layer building process according to the third embodiment.

### DETAILED DESCRIPTION

In a model generation technique of a comparative example, the matrix decomposition and the lowering of rank are performed while maintaining the original layer structure of the convolution layer. In this case, there may be a limit to increasing the processing speed of the convolutional neural network, which is becoming more complex for machine learning models.

Hereinafter, embodiments of the present disclosure will be described with reference to the drawings. It should be noted that the same reference numerals are assigned to corresponding components in the respective embodiments, and overlapping descriptions may be omitted. When only a part of the configuration is described in the respective embodiments, the configuration of the other embodiments described before may be applied to other parts of the configuration. Further, not only the combinations of the configurations explicitly shown in the description of the respective embodiments, but also the configurations of the plurality of embodiments can be partially combined together even if the configurations are not explicitly shown if there is no problem in the combination in particular.

### First Embodiment

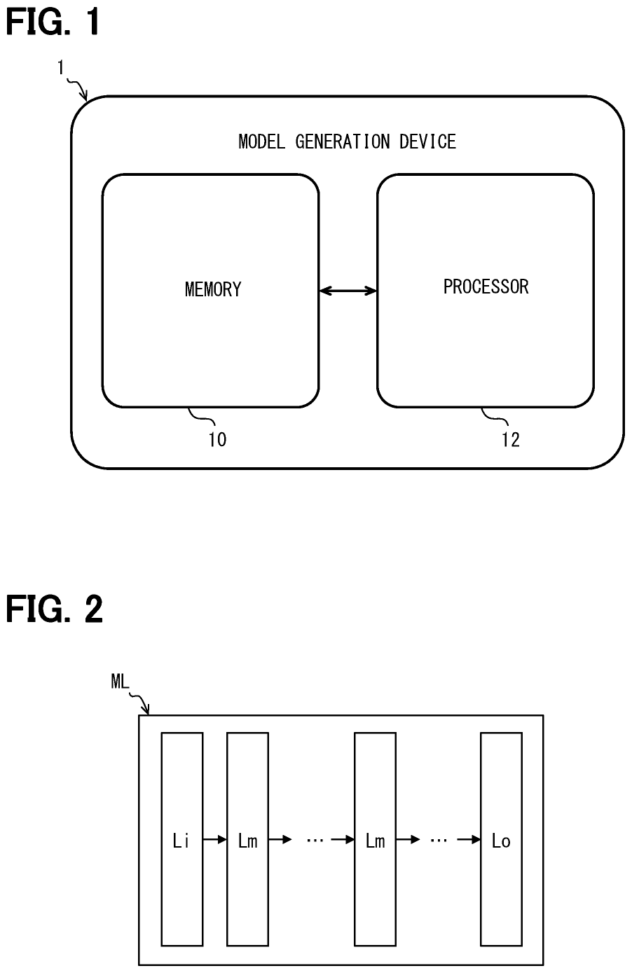

A model generation device 1 of a first embodiment shown in FIG. 1 is configured to generate a machine learning model ML by replacing a convolution layer in a convolutional neural network with a matrix-decomposed decomposition layer. The model generation device 1 includes at least one dedicated computer. The dedicated computer of the model generation device 1 has at least one memory 10 and at least one processor 12.

The memory 10 is at least one type of non-transitory tangible storage medium, such as a semiconductor memory, a magnetic medium, and an optical medium, for non-transitory storage of computer readable programs and data. The processor 12 includes, as a core, at least one type of, for example, a CPU (Central Processing Unit), a GPU (Graphics Processing Unit), an RISC (Reduced Instruction Set Computer) CPU, and the like.

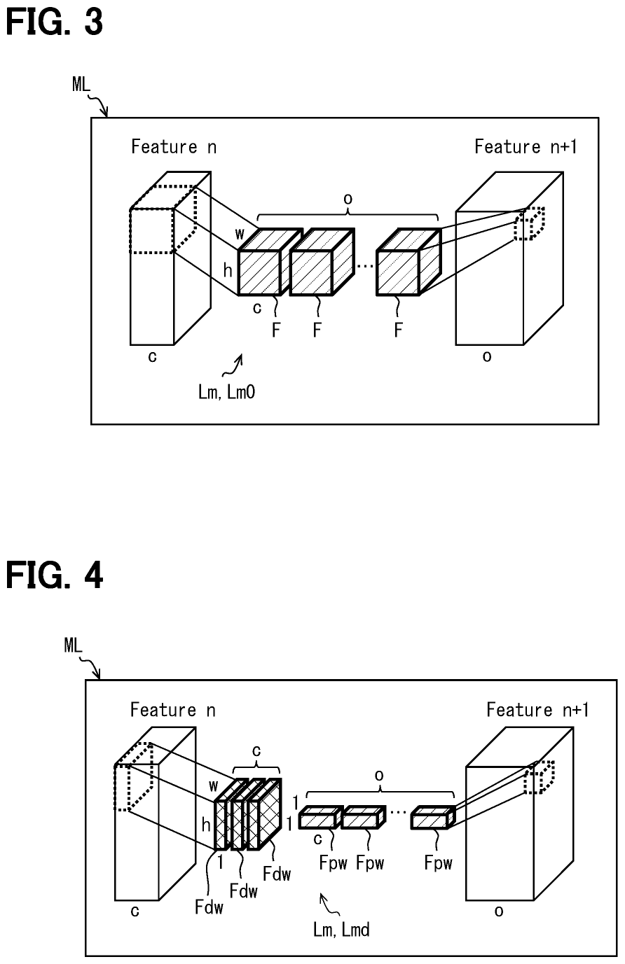

As shown in FIG. 2, the machine learning model ML is configured to provide a convolutional neural network which has multiple convolution layers Lm as intermediate layers between an input layer Li and an output layer Lo. As shown in FIGS. 3, 4, the convolution layer Lm is configured to perform convolution on a feature map n having c channels and output a feature map n+1 having o channels.

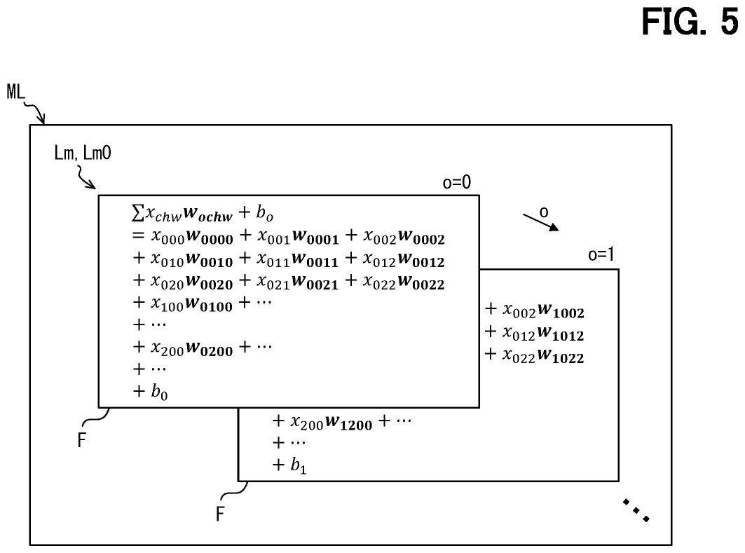

As shown in FIG. 3, an initial layer Lm0, which is an initial structure of the convolution layer Lm, is composed of normal convolution filters (kernal) F for o output channels. The normal convolution filter F is a three-dimensional tensor of size h×w×c. In the initial layer Lm0, the convolution filter F for each of o output channels is defined by a weight matrix having h×w×c weight parameters w_{ochw} shown in FIG. 5. The layer structure of the initial layer Lm0 can be represented by the combination formula shown in FIG. 5, where bₒ is a bias parameter for each output channel.

As shown in FIG. 4, the decomposition layer Lmd replaced from the initial layer Lm0 by the matrix decomposition of the convolution layer Lm is build based on a convolution of a weight matrix product which is a matrix product of weight parameters constituting the decomposition layer Lmd. Especially, the decomposition layer Lmd of the first embodiment is built by convolution of the weight matrix product of the depth-wise (DW) convolution filter Fdw and the point-wise (PW) convolution filter Fpw. The DW convolution filter Fdw and the PW convolution filter Fpw are obtained from the initial layer Lm0 (see FIG. 3) by matrix decomposition.

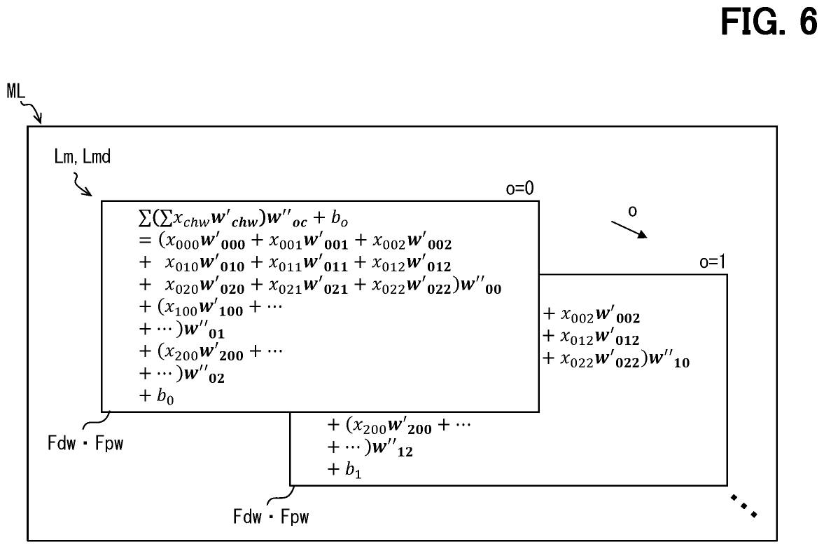

Here, in the decomposition layer Lmd, the DW convolution filters Fdw corresponding to the number c of the input channels are two-dimensional tensors of h×w×1 size shown in FIG. 4, and are defined by a weight matrix having h×w weight parameters w′_{chw} shown in FIG. 6. In contrast, in the decomposition layer Lmd, the PW convolution filters Fpw for the number o of the output channels are one-dimensional tensors of 1×1×c size shown in FIG. 4, and are defined by a weight matrix having weight parameters w″_{oc} shown in FIG. 6. For these reasons, the decomposition layer Lmd can be expressed by the combination formula shown in FIG. 6, where bₒ is a bias parameter for each output channel.

The machine learning model ML including the decomposition layers Lmd replaced from the initial layers Lm0 for each convolution layer Lm are stored in the memory 10 as shown in FIG. 1. The processor 12 of the model generation device 1 also functions as a data processing device by executing data processing based on the machine learning model ML stored in the memory 10. The data processing performed by the model generation device 1 is at least one of, for example, a machine learning process of the machine learning model ML using training data, and an analysis process of the input data passed through the machine learning model ML. The training data and the input data are data relating to at least one of digital data such as image data, audio data, text data, sensing data, vehicle motion data, vehicle running data, and environmental data, for example.

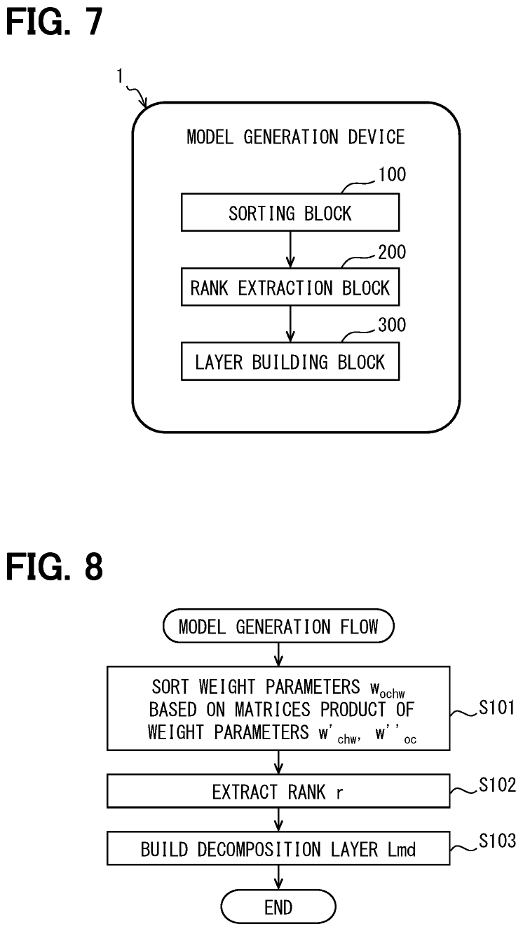

In the model generation device 1, the processor 12 is configured to execute instructions contained in the model generation program stored in the memory 10 for generating the machine learning model ML. Accordingly, the model generation device 1 is configured to build multiple functional blocks for generating the machine learning model ML by replacing the convolution layer Lm from the initial layer Lm0 to the decomposition layer Lmd. In the model generation device 1, the functions of the functional blocks are realized by the matching program stored in the memory 10 which causes the processor 12 to execute the instructions. The functional blocks contain a sorting block 100, a rank extraction block 200, and a layer building block 300 as shown in FIG. 7.

The joint of these blocks 100, 200, 300 allows the model generation device 1 to replace the convolution layer Lm from the initial layer Lm0 to the decomposition layer Lmd, and the model generation method for generating the machine learning model ML is performed according to the model generation flow in FIG. 8. In this model generation flow, “S” means steps of the process executed by instructions included in the generation program.

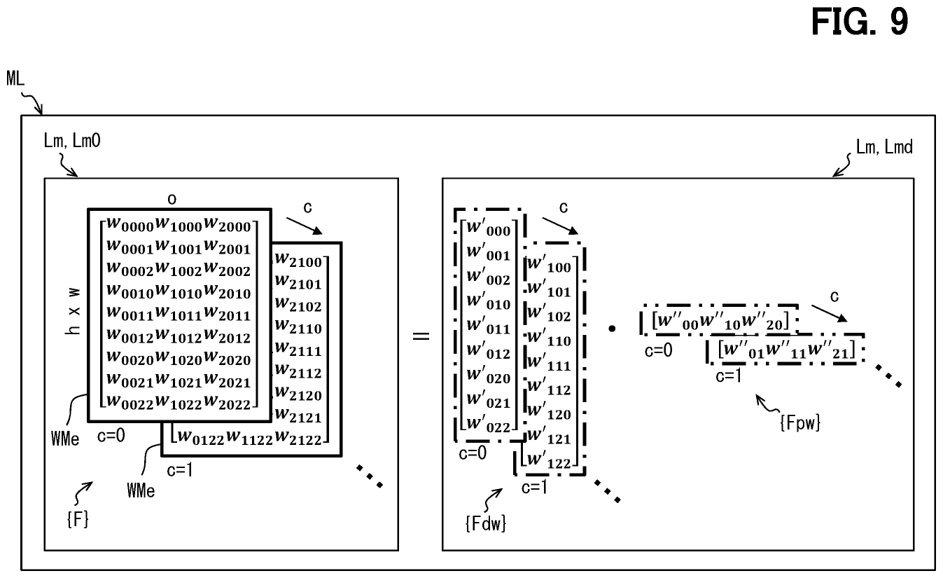

In the model generation flow of the first embodiment, S101-S103 are executed as shown in FIG. 8. Specifically, in S101, the sorting block 100 sorts weight parameters w_{ochw} constituting an original layer. The original layer is the initial layer Lm0 input to the model generation device 1 as the convolution layer Lm which has not been replaced. At this time, the sorting block 100 sorts the weight parameters w_{ochw} of the initial layer Lm0 to constitute an equivalent weight matrix WMe which is equivalent, as shown in FIG. 9, to the weight matrix product of the weight parameters w′_{chw}, w″_{oc} constituting the replaced decomposition layer Lmd.

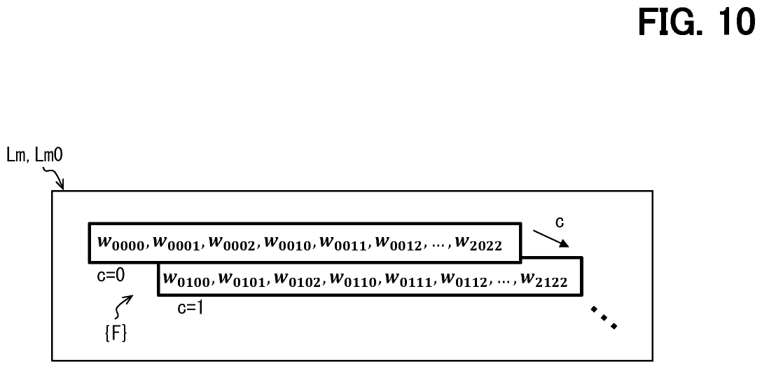

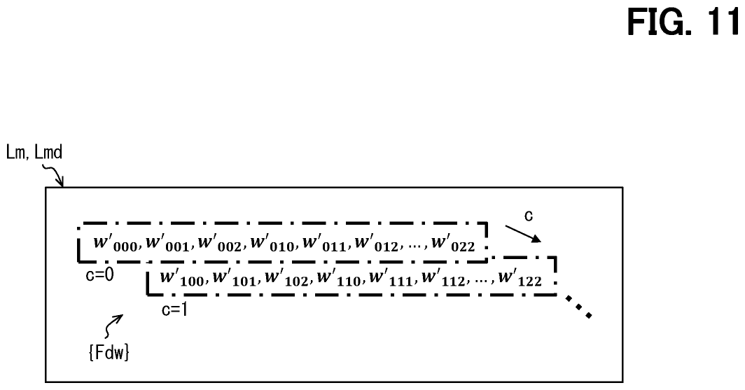

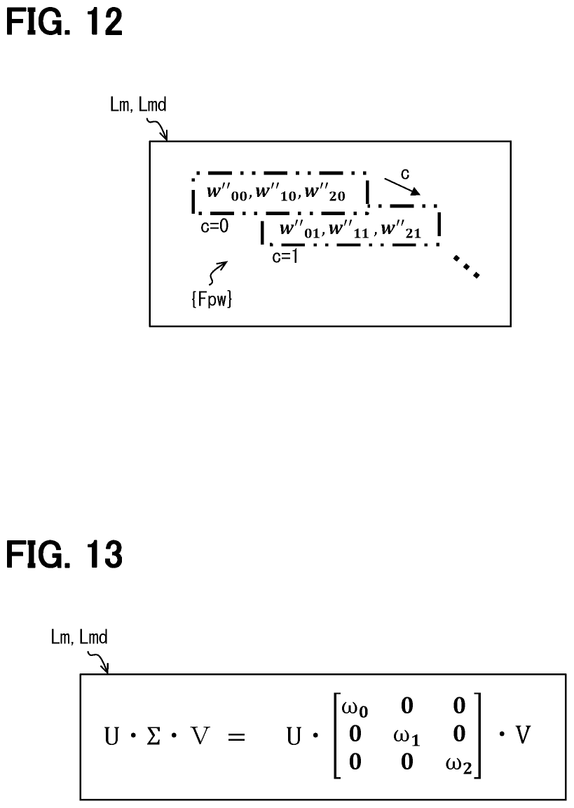

Specifically, the sorting block 100 distributes the weight parameters w_{ochw} of the normal convolutional filter F, which constitutes the initial layer Lm0 as the original layer, for each input channel with the number of channels c as shown in FIG. 10. At the same time, the sorting block 100 distributes the weight parameters w′_{chw} of the DW convolutional filter Fdw and the weight parameters w′_{oc} of the PW convolutional filter Fpw as shown in FIGS. 11, 12. The DW convolution filter Fdw and the PW convolution filter Fpw constitute the decomposition layer Lmd.

After these distributions, the sorting block 100 generates the equivalent weight matrix WMe by sorting the weight parameters w_{ochw} shown in the left side of FIG. 9 to be equivalent to the weight matrix product of the weight parameters w′_{chw}, w″_{oc} shown in the right side of FIG. 9. Especially in the first embodiment, the DW weight matrix which is one-dimensional tensor with a single column is assumed for the weight parameters w′_{chw} of the DW convolution filter Fdw. At the same time, in the first embodiment, the PW weight matrix which is one-dimensional tensor with a single row is assumed for the weight parameters w″_{oc} of the PW convolution filter

Fpw. Based on these assumptions, in the first embodiment, a weight matrix that is a two-dimensional tensor of size (h×w)×o is defined as the equivalent weight matrix WMe.

In S102 shown in FIG. 8, the rank extraction block 200 extracts ranks r by matrix decomposition on the equivalent weight matrix WMe obtained by the sorting block 100 in S101. The rank extraction block 200 of the first embodiment decomposes each equivalent weight matrices WMe for each input channels into a matrix product of a decomposed matrix U related to the DW weight matrix having the weight parameters w′_{chw}, a singular value diagonal matrix Σ, and a decomposed matrix V related to the PW weight matrix having the weight parameters w″_{oc}. In such singular value decomposition for each input channel, the rank extraction block 200 extracts, as the rank r, the indices (in the example shown in FIG. 13, suffix 0, 1, 2 of sign ω) for identifying each singular value ωᵣ which is the eigenvalue of the singular value diagonal matrix Σ. At the same time, the rank extraction block 200 extracts the column of the decomposed matrix U and the row of the decomposed matrix V as the matrix elements corresponding to the rank r. Further, based on these extraction results, the rank extraction block 200 obtains the DW weight matrix from the matrix product of the columns of the decomposed matrix U and the singular value ωᵣ, and the PW weight matrix from the rows of the decomposed matrix V. Alternatively, the rank extraction block 200 may obtain the DW decomposed matrix from the columns of the decomposed matrix U, and the PW weight matrix from the matrix product of the rows of the decomposed matrix V and the singular value ωᵣ.

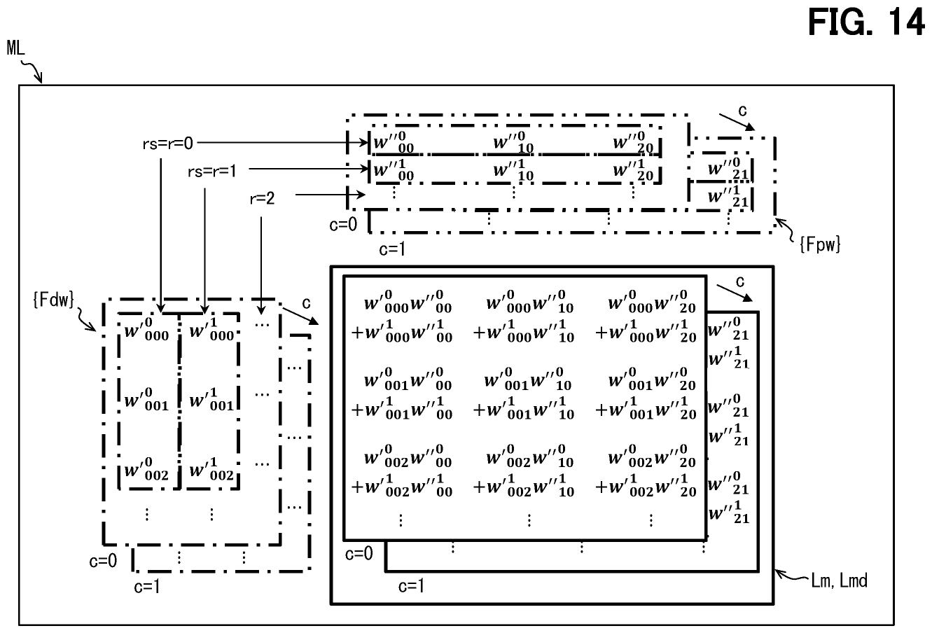

In S103 shown in FIG. 8, the layer building block 300 selects at least one rank rs from the extracted ranks r extracted by the rank extraction block 200 in S102, and builds the decomposition layer Lmd based on the convolution of the weight matrix product corresponding to the selected rank rs. The layer building block 300 of the first embodiment selects the weight matrix products corresponding to at least two selected ranks rs which are less than the number of the ranks r (i.e. the number of the ranks of the singular value diagonal matrix Σ), as the matrix product of the DW weight matrix and the PW weight matrix which are obtained by decomposing the equivalent weight matrix WMe for each input channels having c channels shown in FIG. 14. The ranks r having the greatest singular value ωᵣ of the singular value diagonal matrix Σ may be selected as the selected ranks rs. That is, the ranks r having small singular value ωᵣ of the singular value diagonal matrix Σ may be excluded from the selected ranks rs.

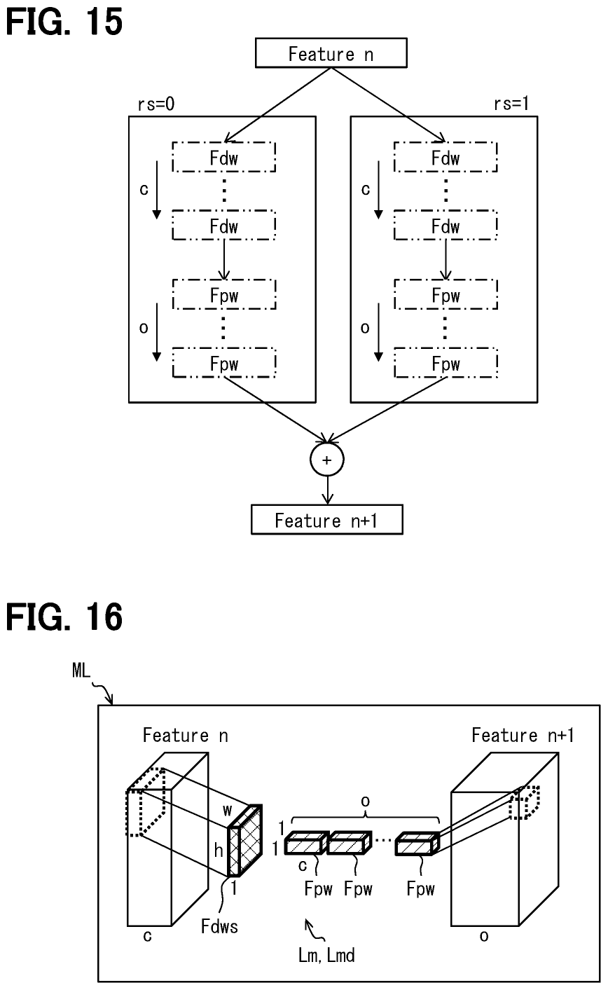

After the selection, the layer building block 300 obtains the decomposition layer Lmd by adding the elements of the feature maps resulting from convolution of the DW weight matrix and the PW weight matrix corresponding to the selected ranks rs as shown in FIGS. 14, 15. Specifically, the layer building block 300 obtains the feature map of h×w×o size by convolution of the PW weight matrix and the feature map of h×w×c size obtained by convolution of the feature map n and the DW weight matrix, and then adding the elements to output the feature map n+1 of h×w×o size. FIG. 14 shows the combination of the weight parameters w′_{chw}, w″_{oc} corresponding to the selected ranks rs as the structure of the decomposition layer Lmd for each channel. However, in FIG. 14, corresponding selected ranks rs are expressed by superscript suffixes assigned to the weight parameters w′_{chw}, w″_{oc} for clarifying the correspondence with the selected ranks rs.

As described above, the layer building block 300 replaces the initial layer Lm0 which is the original layer stored in the memory based on the input with the decomposition layer Lmd built based on the selected ranks rs. At this time, for example, even if it is a combination of DW convolution and PW convolution that requires machine learning, replacement from the convolution layer Lm can be realized while suppressing deterioration and maintaining accuracy without machine learning.

### Operation Effects

Hereinbelow, effects of the above first embodiment will be described.

According to the first embodiment, the weight parameters w_{ochw} constituting the initial layer Lm0 which is the original layer of the convolution layer Lm before the replacement are sorted to constitute the equivalent weight matrix WMe equivalent to the weight matrix product of the weight parameters w′_{chw}, w″_{oc} constituting the decomposition layer Lmd after the replacement. Accordingly, the number of the weight parameters in the decomposition layer Lmd can be reduced by constituting the decomposition layer Lmd based on the convolution of the weight matrix product corresponding to the at least one selected rank rs which is selected from the ranks r extracted by the matrix decomposition of the equivalent weight matrix WMe. Accordingly, the processing speed of the convolutional neural network can be increased. Further, it also reduces the amount of the operations in the convolutional neural network and unifies the layer structure after replacement, making it possible to downsize the model generation device 1 as hardware.

According to the first embodiment, since the decomposition layer Lmd is built based on the convolution of the weight matrix product corresponding to the selected ranks rs whose number is smaller than the number of the ranks r, the number of the weight parameters can be further reduced. Accordingly, the first embodiment can be advantageous for increasing the processing speed of the convolutional neural network. Further, the first embodiment can be advantageous for downsizing the model generation device 1.

According to the first embodiment, since the decomposition layer Lmd is generated by adding the elements of the convolution results of the weight matrix product corresponding to the at least two selected ranks rs, the accuracy of the replacement can be improved. Especially in the first embodiment, since the number of the selected ranks rs is smaller than the number of the ranks r, the accuracy of the replacement by the low-rank approximation can be improved. Accordingly, the first embodiment can be advantageous for increasing the processing accuracy as well as the processing speed of the convolutional neural network. Further, the first embodiment can be advantageous for downsizing the highly accurate model generation device 1.

According to the first embodiment, the equivalent weight matrix WMe is obtained by sorting the weight parameters w_{ochw} of the initial layer Lm0 to be equivalent to the weight matrix product of the DW convolution filter Fdw and the PW convolution filter Fpw which are obtained by the matrix decomposition on the decomposition layer Lmd. This combination of DW convolution and PW convolution, together with the layer construction based on the convolution of the weight matrix product corresponding to the selected ranks rs, can increase the effectiveness of reducing the number of weight parameters in the decomposition layer Lmd. Accordingly, the first embodiment can be advantageous for increasing the processing speed of the convolutional neural network. Further, the first embodiment can be advantageous for downsizing the model generation device 1.

According to the first embodiment, the data processing based on the machine learning model ML of the convolutional neural network generated by the model generation method can realize high processing speed through the decomposition layer Lmd in which the number of the weight parameters are reduced. Further, since the operation amount of the data processing in the convolutional neural network is reduced and the layer structure is unified, the model generation device 1 which is the hardware functioning a data processing device can be downsized.

### Second Embodiment

A second embodiment is a modification of the first embodiment.

In the second embodiment, the decomposition layer Lmd is built based on the convolution of the weight matrix product of the weight sharing DW convolution filter Fdws and PW convolution filter Fpw which are obtained by matrix decomposition of the initial layer Lm0, as shown in FIG. 16. Especially in the decomposition layer Lmd of the second embodiment, single DW convolution filter Fdws is shared for the PW convolution filters Fpw for o output channels which is defined as in the first embodiment.

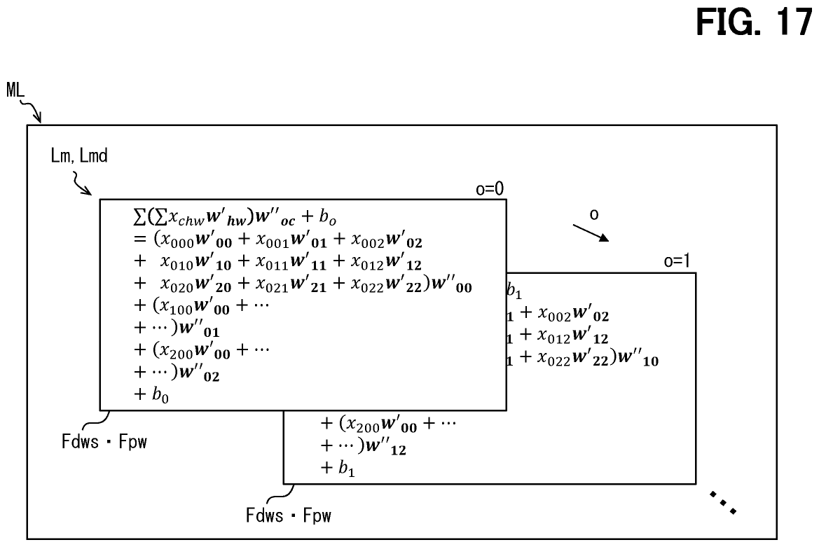

Here, the weight sharing DW convolution filter Fdws is two-dimensional tensors of h×w×1 size shown in FIG. 16, and is defined by a weight matrix having h×w weight parameters w′_{hw} shown in FIG. 17. The decomposition layer Lmd of the second embodiment can be expressed by the combination formula shown in FIG. 17, where bₒ is a bias parameter for each output channel.

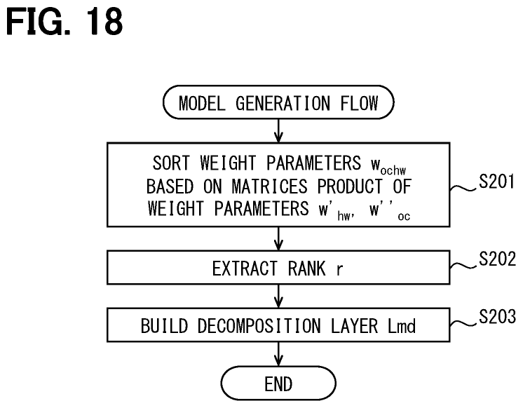

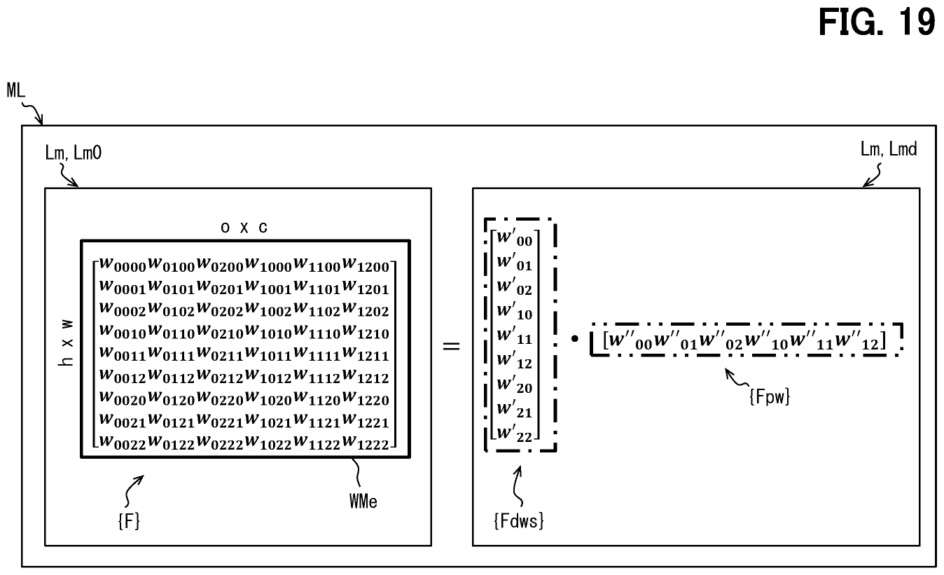

In the model generation flow of the second embodiment shown in FIG. 18, S201-S203 are executed instead of S101-S103 of the first embodiment. Specifically, in S201, the sorting block 100 sorts the weight parameters w_{ochw} of the initial layer Lm0 which is the original layer based on the weight matrix product of the weight parameters w′_{hw}, w″_{oc} constituting the decomposition layer Lmd. The sorting block 100 of the second embodiment generates the equivalent weight matrix WMe by sorting the weight parameters w_{ochw} shown in the left side of FIG. 19 to be equivalent to the weight matrix product of the weight parameters w′_{hw}, w″_{oc} shown in the right side of FIG. 19.

Regarding the weight parameters w″_{oc} of the PW convolution filter Fpw, single row one-dimensional tensor is assumed as in the first embodiment. In contrast, regarding the weight parameters w′_{hw} of the DW convolution filter Fdws, single column one-dimensional tensor is assumed. In the second embodiment, the weight matrix which is a two-dimensional tensor of (h×w)×(o×c) size is defined as the equivalent weight matrix WMe equivalent to the matrix product of the DW weight matrix and the PW weight matrix.

In S202 of the second embodiment shown in FIG. 18, the rank extraction block 200 extracts ranks r by matrix decomposition on the equivalent weight matrix WMe obtained by the sorting block 100 in S201. The rank extraction block 200 of the second embodiment decomposes each equivalent weight matrices WMe into a matrix product of a decomposed matrix U related to the DW weight matrix having the weight parameters w′_{hw}, a singular value diagonal matrix Σ, and a decomposed matrix V related to the PW weight matrix having the weight parameters w″_{oc}. The rank extraction block 200 of the second embodiment extracts the column of the decomposed matrix U and the row of the decomposed matrix V corresponding to the rank r which is the singular value ωᵣ for each singular value diagonal matrix Σ. Further, based on these extraction results, the rank extraction block 200 of the second embodiment obtains the DW weight matrix from the matrix product of the columns of the decomposed matrix U and the singular value ωᵣ, and the PW weight matrix from the rows of the decomposed matrix V. Alternatively, the rank extraction block 200 may obtain the DW decomposed matrix from the columns of the decomposed matrix U, and the PW weight matrix from the matrix product of the rows of the decomposed matrix V and the singular value wr.

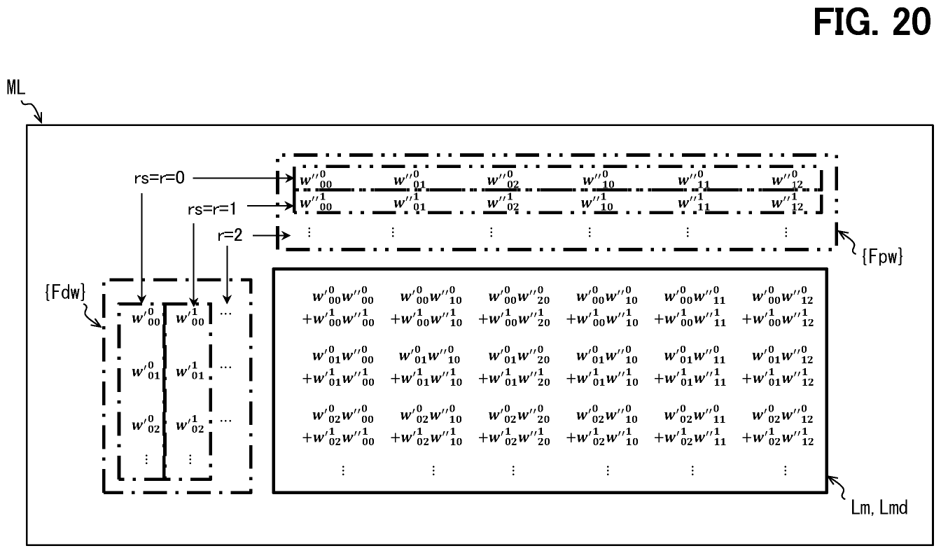

Further, in the model generation flow of the second embodiment, in S203, the layer building block 300 builds the decomposition layer Lmd based on the convolution of the weight matrix product corresponding to the selected rank rs selected from the ranks r extracted by the rank extraction block 200 in S202. The layer building block 300 of the second embodiment selects the weight matrix products corresponding to at least two selected ranks rs which are less than the number of the ranks r, as the matrix product of the DW weight matrix and the PW weight matrix which are obtained by decomposing the equivalent weight matrix WMe as shown in FIG. 20.

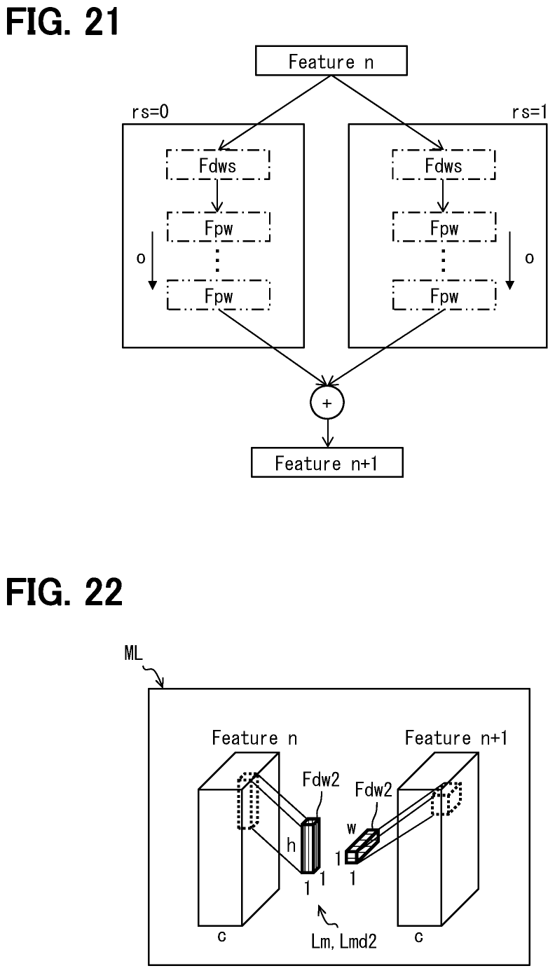

After the selection, the layer building block 300 of the second embodiment obtains the decomposition layer Lmd by adding the elements of the feature maps resulting from convolution of the weight sharing DW weight matrix and the PW weight matrix corresponding to the selected ranks rs as shown in FIGS. 20, 21. FIG. 20 shows the combination of the weight parameters w′_{hw}, w″_{oc} corresponding to the selected ranks rs as the structure of the decomposition layer Lmd. However, in FIG. 20, corresponding selected ranks rs are expressed by superscript suffixes assigned to the weight parameters w′_{hw}, w″_{oc} for clarifying the correspondence with the selected ranks rs. As described above, the layer building block 300 of the second embodiment replaces the initial layer Lm0 which is the original layer stored in the memory based on the input with the decomposition layer Lmd built based on the selected ranks rs.

According to the second embodiment, the weight parameters w_{ochw} constituting the initial layer Lm0 which is the original layer of the convolution layer Lm before the replacement are sorted to constitute the equivalent weight matrix WMe equivalent to the weight matrix product of the weight parameters w′_{hw}, w″_{oc} constituting the decomposition layer Lmd after the replacement. Accordingly, the number of the weight parameters of the decomposition layer Lmd can be reduced by the same principle of the first embodiment, and the processing speed of the convolutional neural network can be increased. Further, it also reduces the amount of the operations in the convolutional neural network and unifies the layer structure after replacement, making it possible to downsize the model generation device 1.

According to the second embodiment, the equivalent weight matrix WMe is obtained by sorting the weight parameters w_{ochw} of the initial layer Lm0 to be equivalent to the weight matrix product of the weight sharing DW convolution filter Fdws and the PW convolution filter Fpw which are obtained by the matrix decomposition on the decomposition layer Lmd. This DW convolution in which the weight parameters w′_{hw} are shared for PW convolution, together with the layer construction based on the convolution of the weight matrix product corresponding to the selected ranks rs, can increase the effectiveness of reducing the number of weight parameters in the decomposition layer Lmd. Accordingly, the second embodiment can be advantageous for increasing the processing speed of the convolutional neural network. Further, the second embodiment can be advantageous for downsizing the model generation device 1.

### Third Embodiment

A third embodiment is a modification of the second embodiment.

As the convolution layer Lm of the third embodiment, a primary decomposition layer Lmd replaced as in the second embodiment from the initial layer Lm0 which is the original layer of the previous processing is redefined as the original layer for the next processing, and the primary decomposition layer Lmd is replaced with a decomposed secondary decomposition layer Lmd2. As shown in FIG. 22, the secondary decomposition layer Lmd2 is built by convolution of the weight matrix product which is obtained by matrix decomposition of the weight-sharing DW convolution filter Fdws of the primary decomposition layer Lmd into a pair of primary DW convolution filter Fdw2.

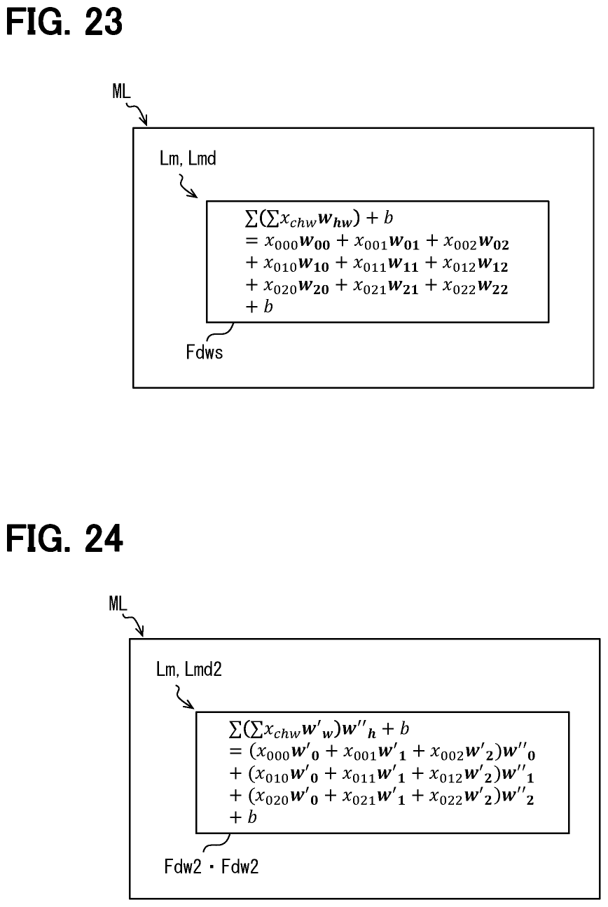

In the description below, regarding the weight-sharing DW convolution filter Fdws of the primary decomposition layer which is the redefined original layer, the weight parameters w′_{hw} described in the second embodiment are redefined as the weight parameters w_{hw} as shown in the combination formula in FIG. 23, where b is the bias parameter.

Here, one of the pair of DW convolution filters Fdws2 is one-dimensional tensors of 1w×1 size shown in FIG. 22, and is defined by a weight matrix having w weight parameters w′_{w} shown in FIG. 24. In contrast, the other one of the pair of DW convolution filters Fdws2 is one-dimensional tensors of h×1×1 size shown in FIG. 22, and is defined by a weight matrix having h weight parameters w″ₕ shown in FIG. 24. For these reasons, the secondary decomposition layer Lmd2 of the third embodiment can be expressed by the combination formula shown in FIG. 24, where b is a bias parameter for each output channel.

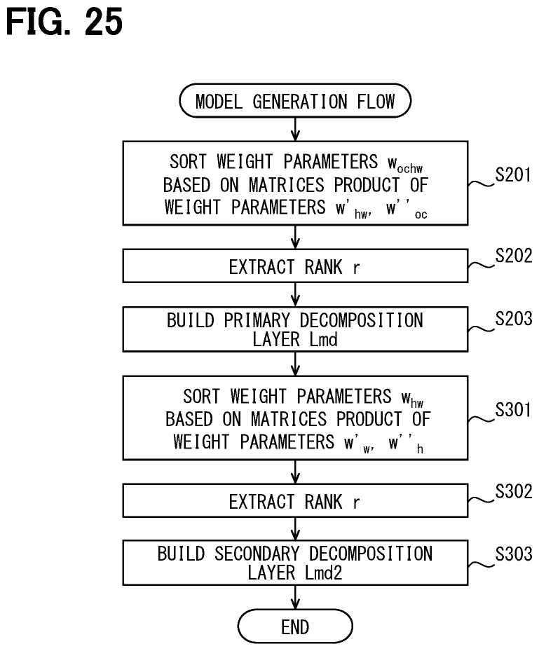

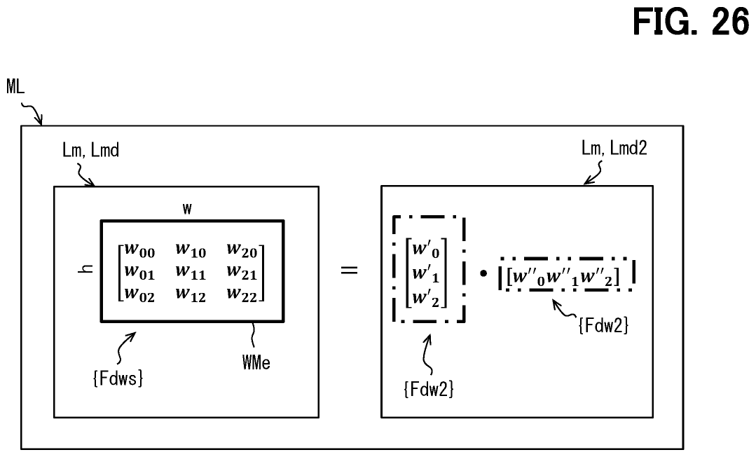

In the model generation flow of the third embodiment shown in FIG. 25, S301-S303 are executed subsequent to S201-S203. Specifically, in S301, the sorting block 100 sorts the weight parameters w_{hw} of the DW convolution filters Fdws in the primary decomposition layer Lmd which is redefined as the original layer based on the weight matrix product of the weight parameters w′_{w}, w″ₕ constituting the secondary decomposition layer Lmd2. The sorting block 100 of the third embodiment generates the equivalent weight matrix WMe by sorting the weight parameters w_{hw} shown in the left side of FIG. 26 to be equivalent to the weight matrix product of the weight parameters w′_{w}, w″ₕ shown in the right side of FIG. 26.

In the DW convolution filters Fdws, the DW weight matrix which is single row one-dimensional tensor is assumed for the weight parameters w′_{w}, and the DW weight matrix which is single column one-dimensional tensor is assumed for the weight parameters w″ₕ. In the third embodiment, in the first embodiment, a weight matrix that is a two-dimensional tensor of size h×w is defined as the equivalent weight matrix WMe.

In S302 of the model generation flow of the third embodiment shown in FIG. 25, the rank extraction block 200 extracts ranks r again by matrix decomposition on the equivalent weight matrix WMe obtained by the sorting block 100 in S301. The rank extraction block 200 of the third embodiment decomposes the equivalent weight matrix WMe into a matrix product of a decomposed matrix U related to the DW weight matrix having the weight parameters w′_{w}, a singular value diagonal matrix Σ, and a decomposed matrix V related to the DW weight matrix having the weight parameters w″ₕ. The rank extraction block 200 of the third embodiment extracts the column of the decomposed matrix U and the row of the decomposed matrix V corresponding to the rank r which is the singular value ωᵣ for each singular value diagonal matrix Σ. Further, based on these extraction results, the rank extraction block 200 of the third embodiment obtains one of the DW weight matrices from the matrix product of the columns of the decomposed matrix U and the singular value ωᵣ, and the other one of the DW weight matrices from the rows of the decomposed matrix V. Alternatively, the rank extraction block 200 may obtain one of the DW decomposed matrices from the columns of the decomposed matrix U, and the other one of the DW weight matrices from the matrix product of the rows of the decomposed matrix V and the singular value ωᵣ.

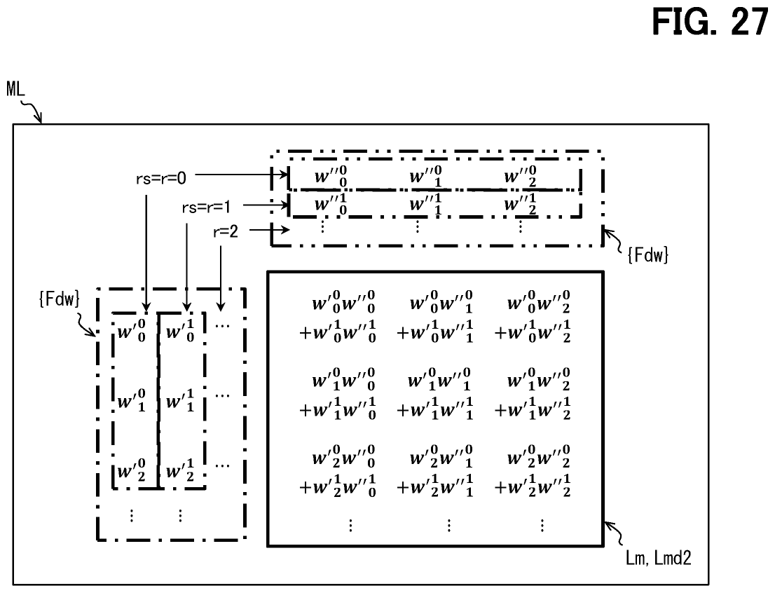

Further, in the model generation flow of the third embodiment, in S303, the layer building block 300 builds the secondary decomposition layer Lmd2 based on the convolution of the weight matrix product corresponding to the selected rank rs selected from the ranks r extracted by the rank extraction block 200 in S302. The layer building block 300 of the third embodiment selects the weight matrix products corresponding to at least two selected ranks rs which are less than the number of the ranks r, as the matrix product of the pair of DW weight matrices which are obtained by decomposing the equivalent weight matrix WMe as shown in FIG. 27.

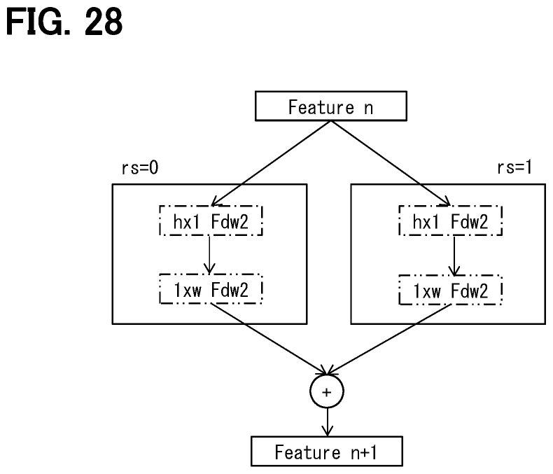

After the selection, the layer building block 300 of the third embodiment obtains the decomposition layer Lmd by adding the elements of the feature maps resulting from convolution of the pair of one-dimensional DW weight matrices corresponding to the selected ranks rs as shown in FIGS. 27, 28. FIG. 27 shows the combination of the weight parameters w′_{w}, w″ₕ corresponding to the selected ranks rs as the structure of the secondary decomposition layer Lmd2. However, in FIG. 27, corresponding selected ranks rs are expressed by superscript suffixes assigned to the weight parameters w′_{w}, w″ₕ for clarifying the correspondence with the selected ranks rs. Accordingly, the layer building block 300 of the third embodiment replaces, with the secondary decomposition layer Lmd2 built based on the selected ranks rs, the layer structure related to the weight-sharing convolution filter Fdws of the primary decomposition layer Lmd which is the original layer stored in the memory as a result of S201-S203.

According to the above-described third embodiment, the secondary decomposition layer Lmd2 replaced from the primary decomposition layer Lmd which is the previous original layer is redefined as the next original layer. As a result, the weight parameters w_{hw} constituting the primary decomposition layer Lmd is sorted to constitute the equivalent weight matrix WMe equivalent to the weight matrix product of the weight parameters w′_{w}, w″ₕ constituting the secondary decomposition layer Lmd2. According to this, from the same principle as in the first embodiment, the secondary decomposition layer Lmd2 whose number of the weight parameters is further reduced from the primary decomposition layer Lmd can be built by the next replacement. Accordingly, the third embodiment can be advantageous for increasing the processing speed of the convolutional neural network. Further, the third embodiment is also advantageous to reduce the amount of the operations in the convolutional neural network and unifies the layer structure after replacement, making it possible to downsize the model generation device 1.

According to the third embodiment, the equivalent weight matrix WMe equivalent to the weight matrix product of a pair of one-dimensional DW convolution filters Fdw2 obtained by matrix decomposition on secondary decomposition layer Lmd2 is obtained by sorting the weight parameters w_{hw} of the primary decomposition layer Lmd. This combination of one-dimensional DW convolutions, together with the layer construction based on the convolution of the weight matrix product corresponding to the selected ranks rs, can increase the effectiveness of reducing the number of weight parameters in the secondary decomposition layer Lmd2. Accordingly, the third embodiment can be advantageous for increasing the processing speed of the convolutional neural network. Further, the third embodiment can be advantageous for downsizing the model generation device 1.

### Other Embodiments

Although a plurality of embodiments have been described above, the present disclosure is not to be construed as being limited to these embodiments, and can be applied to various embodiments and combinations within a scope not deviating from the gist of the present disclosure.

The dedicated computer of the model generation device 1 of the modification example may include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

In a modification example, the order of filters Fdw, Fpw in the weight matrix product may be switched from the order described in the first embodiment. In a modification example, the order of filters Fdws, Fpw in the weight matrix product may be switched from the order described in the second embodiment. In a modification example, the order of filters Fdw2, Fdw2 in the weight matrix product may be switched from the order described in the third embodiment.

In a modification example, the matrix decomposition may be performed by a method different from the singular value decomposition such as a principal component analysis, and eigen value decomposition. In a modification example, the number of the selected ranks rs may be adjusted based on the tradeoff of the processing speed and the processing accuracy. In a modification example, the weight parameters of the decomposition layers Lmd, Lmd2 may be learned after the replacement by machined learning by reducing the number of the selected ranks rs.

In a modification example, a single rank r may be selected as the selected rank rs. Preferably, a rank r (0 in FIG. 13) corresponding to a largest singular value ωᵣ (ω0 in FIG. 13) may be selected as the selected rank rs. In this case, the decomposition layers Lmd, Lmd2 may be built based on convolution of the weight matrix product corresponding to the single selected rank rs. In a modification example, all ranks r may be selected as the selected rank rs. In this case, the decomposition layers Lmd, Lmd2 may be built by adding the elements of the convolution results of the weight matrix product corresponding to the selected ranks rs.

In a modification example, the decomposition layer Lmd of the third embodiment may be the initial layer Lm0 of the convolution layer Lm. In this case, S201-S203 are omitted from the model generation flow of the third embodiment, and only S301-S303 are executed. Accordingly, the layer Lmd which is the original layer may be replaced with the decomposed layer Lmd2.

In a modification example, the model generation device 1 may not have functions as a data processing device. The above-described embodiments and the modification example may be realized as a semiconductor device (e.g. semiconductor chip) that has at least one processor 12 and at least one memory 10 of the model generation device 1.

What is claimed is:

1. A model generation method for a processor to generate a machine learning model by replacing a convolution layer of a convolutional neural network with a decomposition layer by matrix decomposition, the model generation method comprising:
sorting weight parameters constituting an original layer of the convolution layer to constitute an equivalent weight matrix equivalent to a weight matrix product which is a product of matrices of weight parameters constituting the decomposition layer;
extracting a plurality of ranks by matrix decomposition on the equivalent weight matrix; and
building the decomposition layer based on convolution of the weight matrix product corresponding to at least one selected ranks selected from the plurality of ranks.

2. The model generation method according to claim 1, wherein
in the building the decomposition layer, building the decomposition layer based on convolution of the weight matrix product corresponding to the at least one selected ranks whose number is smaller than the plurality of ranks.

3. The model generation method according to claim 1, wherein
a number of the at least one selected ranks is at least two, and
in the building the decomposition layer, generating the decomposition layer by adding elements of results of convolution of the weight matrix product corresponding to the at least two selected ranks.

4. The model generation method according to claim 1, wherein
in the sorting the weight parameters, obtaining the equivalent weight matrix, by the sorting, equivalent to the weight matrix product of a depth-wise convolution filter and a point-wise convolution filter obtained by matrix decomposition on the decomposition layer.

5. The model generation method according to claim 1, wherein
in the sorting the weight parameters, obtaining the equivalent weight matrix, by the sorting, equivalent to the weight matrix product of a weight-sharing depth-wise convolution filter and a point-wise convolution filter obtained by matrix decomposition on the decomposition layer.

6. The model generation method according to claim 1, wherein
in the sorting the weight parameters, obtaining the equivalent weight matrix, by the sorting, equivalent to the weight matrix product of a pair of one-dimensional depth-wise convolution filters obtained by matrix decomposition on the decomposition layer.

7. The model generation method according to claim 1, further comprising:
in the sorting the weight parameters, redefining the decomposition layer which was replaced from the original layer in a previous process as the original layer in a next process.

8. A computer program product stored on at least one non-transitory computer readable medium for generating a machine learning model by replacing a convolution layer of a convolutional neural network with a decomposition layer by matrix decomposition, the model generation program comprising instructions configured to, when executed by at least one processor, cause the at least one processor to:
sort weight parameters constituting an original layer of the convolution layer to constitute an equivalent weight matrix equivalent to a weight matrix product which is a product of matrices of weight parameters constituting the decomposition layer;
extract a plurality of ranks by matrix decomposition on the equivalent weight matrix; and
build the decomposition layer based on convolution of the weight matrix product corresponding to at least one selected ranks selected from the plurality of ranks.

9. A model generation device configured to generate a machine learning model by replacing a convolution layer of a convolutional neural network with a decomposition layer by matrix decomposition, the model generation device comprising:
a processor configured to:
sort weight parameters constituting an original layer of the convolution layer to constitute an equivalent weight matrix equivalent to a weight matrix product which is a product of matrices of weight parameters constituting the decomposition layer;
extract a plurality of ranks by matrix decomposition on the equivalent weight matrix; and
build the decomposition layer based on convolution of the weight matrix product corresponding to at least one selected ranks selected from the plurality of ranks.

10. A data processing device comprising:
a storage medium that stores the machine learning model of the convolutional neural network generated by the model generation method according to claim 1; and
a processor configured to execute data processing based on the machine learning model stored in the storage medium.
